(19) United States
(12) Patent Application Publication
(10) Pub. No.: US 2024/0375743 A1
(43) Pub. Date: Nov. 14, 2024

(54) ELECTRIC SELF-BALANCING SEATED VEHICLE

(71) Applicant: Kevin Palmer, Reno, NV (US)

(72) Inventor: Kevin Palmer, Reno, NV (US)

(21) Appl. No.: 18/660,225

(22) Filed: May 10, 2024

Related U.S. Application Data
(60) Provisional application No. 63/501,330, filed on May 10, 2023.
(60) Provisional application No. 63/502,107, filed on May 14, 2023.

(51) Int. Cl. B62K 11/00; A63C 17/14; B62J 1/08; B62J 1/28; B62J 45/41; B62J 50/21; B62K 1/00; B62K 23/00; B62L 3/02

(52) U.S. Cl. CPC B62K 11/007; B62J 1/08; B62J 1/28; B62J 45/41; B62J 50/21; B62K 1/00; B62K 23/00; B62L 3/02; A63C 17/14

(57) ABSTRACT

The embodiments presented within present a self-balancing single wheeled electric vehicle. One embodiment has a seat attached to a frame with a seat low enough that a user can set a tilt of the seat with a foot of the user. The frame also has a motorized hub and wheel attached. A controller activates the motorized hub to move the vehicle when the seat is tilted forward and activates the motorized hub to slow the vehicle when the seat is tilted backward.

### FIELD

The present disclosure is directed to self-balancing vehicles. The present application claims priority to U.S. Provisional Application No. 63/501,117 filed May 9, 2023, U.S. Provisional Application No. 63/501,330 filed May 10, 2023, and U.S. Provisional Application No. 63/502,107 filed May 14, 2023. The entire disclosures of these applications are incorporated herein by reference.

### BACKGROUND

Self-balancing electric vehicles use an electric motor for both propulsion and balance, using rider leaning inputs to accelerate and decelerate.

Self-balancing vehicles and other electric mobility devices can be difficult to ride. Most of these vehicles are meant to be ridden while standing. Electric vehicles ridden while standing provide a high center of gravity. This creates an unstable condition in motion, especially when coupled with self-balancing features of many electric vehicles. Standing on self-balancing mobility devices demands a high level of balance and coordination from the user, requiring a high level of concentration and skill to operate.

With some devices having capabilities of speeds up to 30 mph or more, falls or crashes can cause physical harm or even death. Helmets, which should always be worn while using the self-balancing vehicles, reduce the likelihood of death but not other injuries.

It is therefore desirable to design a self-balancing vehicle where the rider is seated and can stabilize themselves on the ground both while stopped and while in motion using wheels mounted on their feet. This allows a person to ride the vehicle or device from a lower center of gravity, making them more stable and less likely to fall off. It allows people to ride further with less fatigue and allows people with balance or physical disabilities to enjoy self-balancing electric vehicles.

Sitting on self-balancing vehicles and mobility devices instead of standing on them allows wheels to be used on the person's feet, giving additional ground contact points versus the vehicle or device on its own, which increases stability and steering, both reducing the likelihood of falling or crashing. Most electric vehicles which self-balance are known to have a nose-diving tendency when exerting full acceleration or running low on batteries. Sitting reduces this risk significantly on its own, but coupled with wheels on the person's feet, it makes nose dives extremely unlikely if not impossible. The person's feet are out in front of them to catch the vehicle or device from diving too hard and the wheels allow them to continue rolling onward.

Standing on self-balancing vehicles creates a higher hazard in the case of a failure or crash when compared to sitting, as the distance from a person's head to the ground will be greater when standing causing the person to have a higher momentum upon impact of the ground during a fall as compared to a person who falls from a seated position.

Other self-balancing vehicles such as electric unicycles, may offer seats as add-ons or even built-in, but they are designed for the rider's feet to be on the device rather than on the ground.

The present invention seeks to provide a solution to this problem by providing a vehicle specifically intended to be seated on while using wheels mounted to the feet for extra stability and control.

### SUMMARY

The embodiments presented within provide devices, systems, and methods of a vehicle which is designed to self-balance along the direction of travel of the tire, while also allowing a rider to aid in the balance and steering of the vehicle using foot-mounted wheels.

In one embodiment, a self-balancing single wheeled electric vehicle is presented. The vehicle includes a seat attached to a frame where the seat is positioned low enough that a user can set a tilt of the seat with a foot of the user. The vehicle includes a motorized hub attached to the frame and a wheel attached to the motorized hub. The vehicle includes a controller that activates the motorized hub to move forward when the seat is tilted forward and activates the motorized hub to slow when the seat it tilted backward.

In another embodiment, the vehicle seat has a seat bottom height of less than 22 inches from the ground in level riding position.

### BRIEF DESCRIPTION OF THE DRAWINGS

FIG. 1A is an illustration of a perspective view of one embodiment of a vehicle with the lawn-chair style seat configuration with a person seated on the vehicle.

FIG. 1B is an illustration of a side view of the vehicle with a person seated on the vehicle.

FIG. 1C is an illustration of a perspective view of the vehicle without a person.

FIG. 1D is an illustration of a side view of the vehicle without a person.

FIG. 2A is an illustration of a perspective view of one embodiment of a vehicle with a motorcycle-style seat configuration with a person seated on the vehicle.

FIG. 2B is an illustration of a side view of the vehicle with a person seated on the vehicle.

FIG. 2C is an illustration of a perspective view of the vehicle without a person seated on the vehicle.

FIG. 2D is an illustration of a side view of the vehicle without a person seated on the vehicle.

FIG. 3A is an illustration of a perspective view of a vehicle without a seat attached.

FIG. 3B is an illustration of a side view of the vehicle without a seat attached.

FIG. 3C is an illustration of a perspective view of the vehicle without a seat attached.

FIG. 3D is an illustration of an overhead view of the vehicle without a seat attached.

FIG. 3E is an illustration of a front view of the vehicle without a seat attached.

FIG. 3F is an illustration of a side view of the vehicle without a seat attached.

FIG. 3G is an illustration of a detail view of FIG. 3E of the vehicle without a seat attached.

FIG. 4 is an illustration of a side view of a lawn-chair style seat.

FIG. 5 is an illustration of a side view of a motorcycle-style seat.

FIG. 6A is an illustration of a side view of a vehicle exploded to show components.

FIG. 6B is an illustration of a front view of the vehicle exploded to show components.

FIG. 7A is an illustration of a sensor for rider detection.

FIG. 7B is an illustration of an exploded sensor view.

FIG. 7C is an illustration of a detailed exploded view of sensor functionality.

FIG. 8A is an illustration of a chair with sensor and rider in place.

FIG. 8B is an illustration of an exploded view of chair with rider.

FIG. 8C is an illustration of a detail view showing exploded location of sensor under rider.

FIG. 9A is an illustration of a view of the seated self-balancing electric unicycle device.

FIG. 9B is an illustration of a view of a seat removed from an electric unicycle device.

FIG. 9C is an illustration of an exploded view of a seat pad sensor in a seat.

FIG. 10A is an illustration of a perspective view of a self balancing device with an ATV-style seat.

FIG. 10B is an illustration of a side view of the self balancing device.

FIG. 10C is an illustration of a side view of the ATV-style seat.

FIG. 10D is an illustration of an exploded view of the ATV-style seat showing sensor location.

FIG. 10E is an illustration of a perspective exploded view of the ATV-style seat showing sensor location.

FIG. 11A is an illustration of side view of a seat mounted to a self-balancing unicycle skateboard.

FIG. 11B is an illustration of a cutaway front view along plane A of FIG. 11A.

FIG. 12A is an illustration of a side cutaway view of view of a seat mounted to a self-balancing unicycle skateboard with handlebars and footpad sensor activation protrusions.

FIG. 12B is an illustration of a front view of FIG. 12A.

FIG. 13A is an illustration of side view of foot mounted wheel assembly with automatic braking function.

FIG. 13B is an illustration of perspective view of FIG. 13A

FIG. 14A is an illustration of a side view of foot mounted wheel assembly with onboard sensors and electric braking.

FIG. 14B is an illustration of a perspective view of FIG. 14A.

### DETAILED DESCRIPTION

Representative embodiments are described below with reference to the accompanying drawings. It should be understood that the following description is intended to describe representative embodiments, and not to limit the appended claims. In the present description, certain terms have been used for brevity, clearness, and understanding. No unnecessary limitations are to be applied there from beyond the requirement of the prior art because such terms are used for descriptive purposes only and are intended to be broadly construed. The different systems and methods described herein may be used alone or in combination with other systems and methods. Various equivalents, alternatives and modifications are possible within the scope of the appended claims. Each limitation in the appended claims is intended to invoke interpretation under 35 U.S.C. § 112, sixth paragraph, only if the terms “means for” or “step for” are explicitly recited in the respective limitation.

As described above, prior systems do not offer any additional balance or support other than the torque of the motor(s) and are less stable than using foot-mounted wheels to create a tricycle-type footprint with three points of contact on the ground.

The primary goal was to create a device designed to be seated on rather than stood upon, while being seated low enough to the ground to allow the rider's legs to control their forward and rearward tilt for speed control. The rider may also control their side-to-side tilt for directional control.

The vehicle may be compact and lightweight for easy transportation. It may be easily charged and have a range of at least 10 miles at 15 mph or greater.

For greatest safety, the vehicle may deactivate automatically when the rider dismounts the vehicle. While braking can be achieved by leaning back, this can be difficult when going downhill especially with short legs, so an alternative stopping method is desirable.

The resulting electric vehicle is most like an electric unicycle, where the rider is directly centered over the motor and tire. However, unlike other electric unicycles, the disclosed vehicle does not need foot pegs or other mechanisms of keeping the feet of a rider on the vehicle. In order to provide a low seating position, a small 6″ electric hub motor or similar may be used, with a wide footprint for extra stability. These dimensions allow for a seat height, in one embodiment, that is no more than 22″ off the ground. A frame may be mounted to the axle of the wheel which holds the rest of the assembly up off the ground during use. The frame may have a latching system for removable seat options, including a motorcycle-style seat, a lawn-chair style seat, a beach-style seat, or other seat options. Each seat may include a rider detection sensor used for motor activation and/or control, and/or a brake lever used as an analog input for motor activation and/or control.

Motor control may be achieved using a Variable Electronic Speed Control (VESC) controller with built-in Inertial Measurement Unit (IMU) that continuously detects the orientation and speed of the vehicle and controls the speed and direction of the motor based upon those inputs. Alternative configurations of the motor are possible. In other embodiments the IMU may be integrated into a separate controller, may be separate from either motor assembly or controller assembly, or may not be present altogether.

Vehicle control is achieved by the rider leaning forward to accelerate and leaning back to decelerate. This motion is made very simple by extending the legs to accelerate and bending them to decelerate.

Steering may be performed mostly using the wheels attached to the feet, which is what makes disclosed embodiments so much more controllable, especially at low speeds, when compared to its counterparts where the rider's feet are supported on the vehicle. At slow speeds the rider can point their toes to help rotate the vehicle in the direction they're pointing and steer with ease even in tight or crowded environments. At higher speeds the wheels are used to help lean the vehicle to the left or the right causing it to turn in a “carve” or leaning turn rather than the low-speed rotational turn. In one embodiment, wheels are only attached to the heels of the shoes of the rider. This embodiment allows the user to step off the chair safely without rolling.

In order to make the device portable, the seat options may be made to be removable. A motorcycle-style seat may be made to offer handlebars which provide additional leverage for leaning the vehicle giving additional control for acceleration, braking, and steering. A lawn-chair style seat allows a more relaxed riding position with back support and still provides sufficient control when using the arm rests as leverage. A lawn-chair style seat folds for easier transportation. Handlebars of the motorcycle-style seat may be collapsible and removable for the same reason.

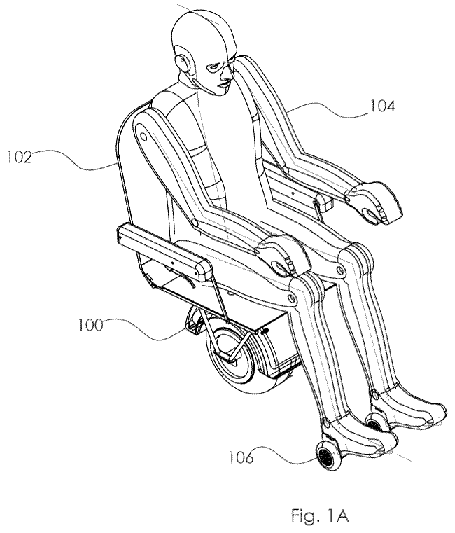

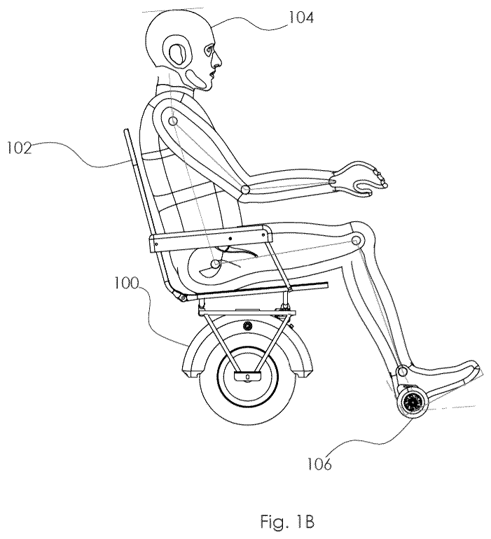

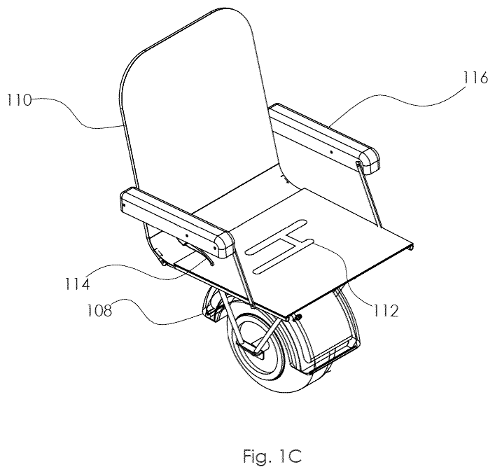

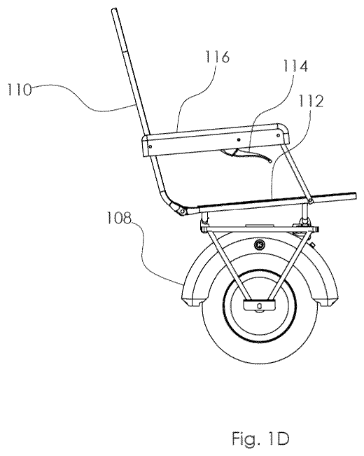

FIG. 1A is an illustration of a perspective view of one embodiment of a vehicle with the lawn-chair style seat configuration with a rider seated on the vehicle. Electric self-balancing seated vehicle 100 with folding lawn-chair style seat 102 is shown with rider 104 wearing foot mounted wheels 106.

FIG. 1B is an illustration of a side view of the vehicle with a rider seated on the vehicle.

FIG. 1C is an illustration of a perspective view of the vehicle without a rider. Electric self-balancing seated vehicle 108 with folding lawn-chair style seat 110 contains rider seat pad detection sensor 112, brake lever 114, and arm rests 116. The folding lawn-chair style seat 110 may fold up for easy storage.

FIG. 1D is an illustration of a side view of the vehicle without a rider.

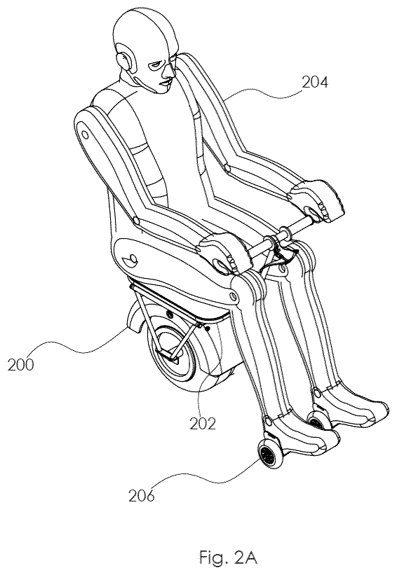

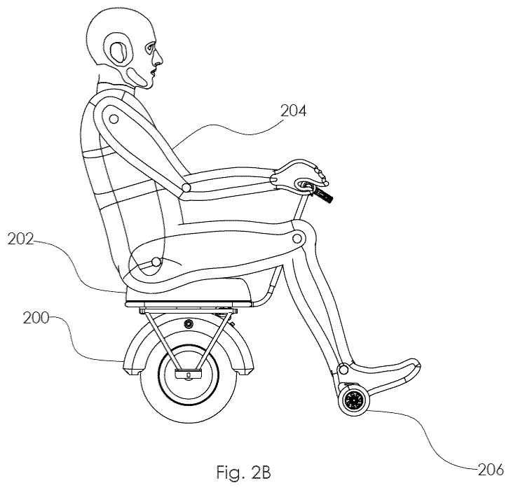

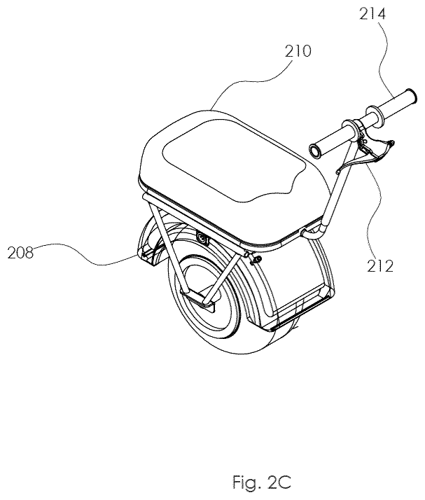

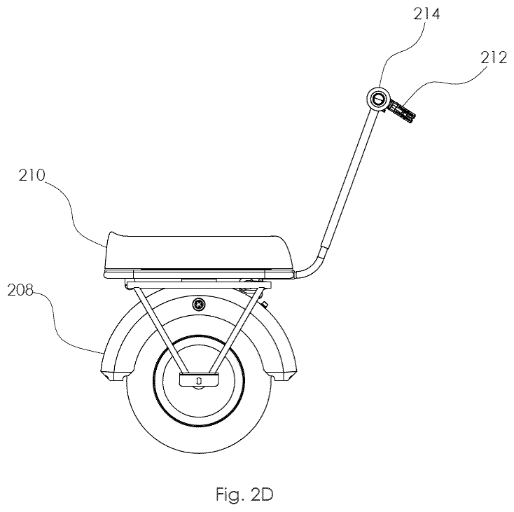

FIG. 2A is an illustration of a perspective view of one embodiment of a vehicle with a motorcycle-style seat configuration with a rider seated on the vehicle. Electric self-balancing seated vehicle 200 with motorcycle-style seat 202 is shown with rider 204 wearing foot mounted wheels 206.

FIG. 2B is an illustration of a side view of the vehicle with a rider seated on the vehicle.

FIG. 2C is an illustration of a perspective view of the vehicle without a rider seated on the vehicle. Electric self-balancing seated vehicle 208 with motorcycle-style seat 210 includes brake/control lever 212 and handlebars 214. The handlebar 216 may fold up for easy storage.

FIG. 2D is an illustration of a side view of the vehicle without a rider seated on the vehicle.

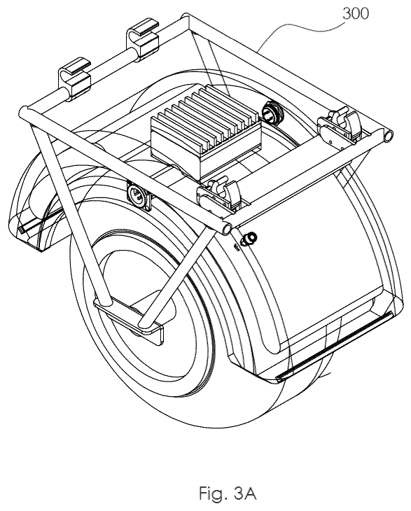

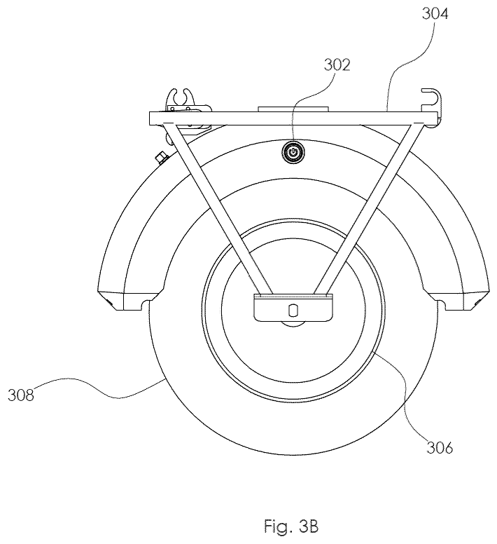

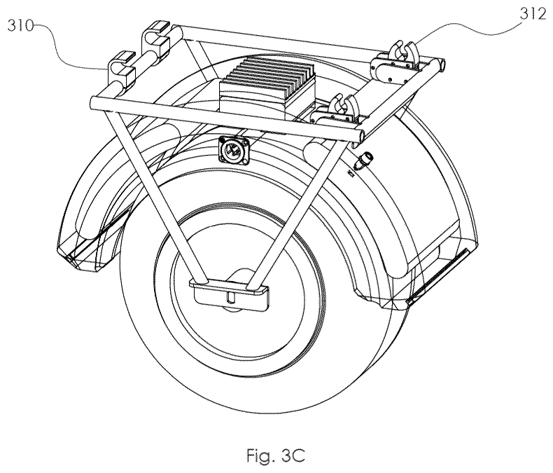

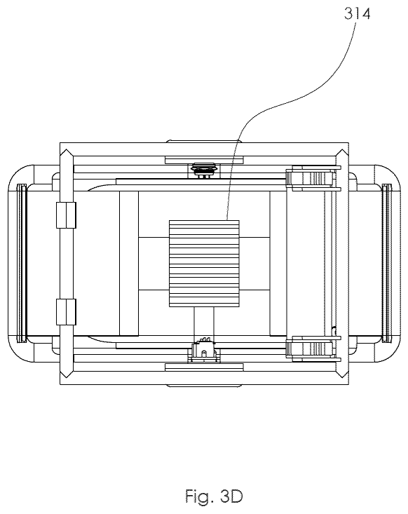

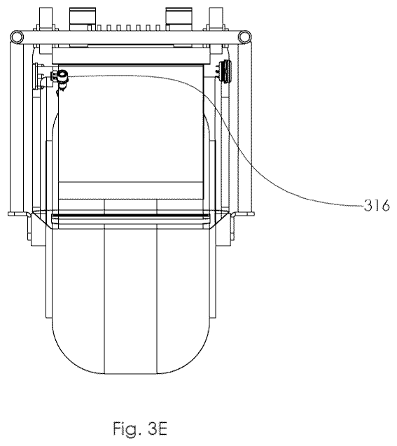

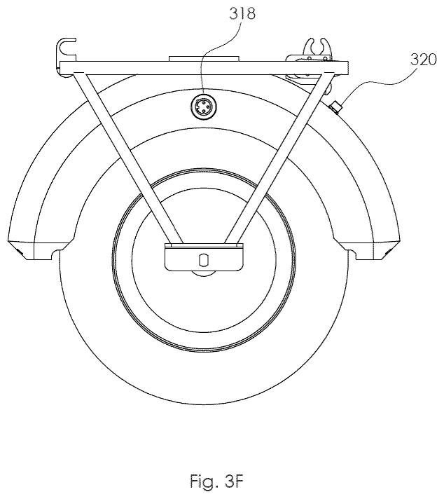

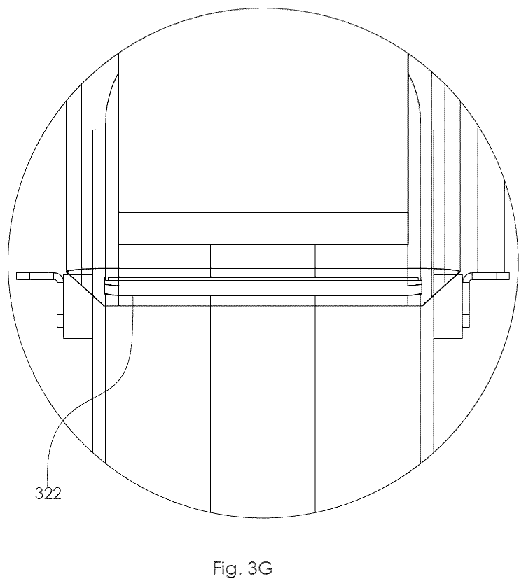

FIG. 3A is an illustration of a perspective view of a vehicle without a seat attached. Electric self-balancing seated vehicle 300 is shown with one embodiment of stated features.

FIG. 3B is an illustration of a side view of the vehicle without a seat attached. Power switch 302 is usable to activate or deactivate the vehicle. Frame 304 contains hub motor 306 and tire 308.

FIG. 3C is an illustration of a perspective view of the vehicle without a seat attached showing seat attachment hardware. In one embodiment, seat mount slotted clamps 310 and seat mount bear claw clamps 312 may be used to attach different types of seats.

FIG. 3D is an illustration of an overhead view of the vehicle without a seat attached. In the embodiment, heat sink 314 is shown.

FIG. 3E is an illustration of a front view of the vehicle without a seat attached. In the embodiment, seat and brake sensors port 316 is shown.

FIG. 3F is an illustration of a side view of the vehicle without a seat attached. In the embodiment, charge port 318 and seat and brake sensors port 320 are shown.

FIG. 3G is an illustration of a detail view of FIG. 3E of the vehicle without a seat attached. In the embodiment, headlight 322 is shown. A similar arrangement can allow for a taillight on the opposite fender of the vehicle.

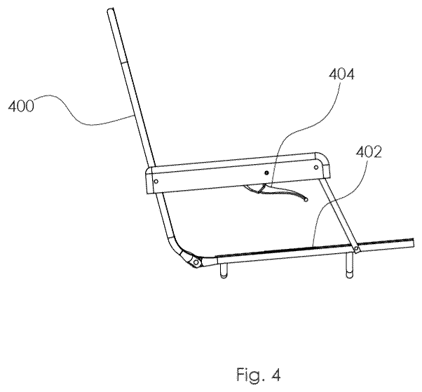

FIG. 4 is an illustration of a side view of a lawn-chair style seat. Folding lawn-chair style chair seat 400 includes rider seat pad detection sensor 402 and brake lever 404.

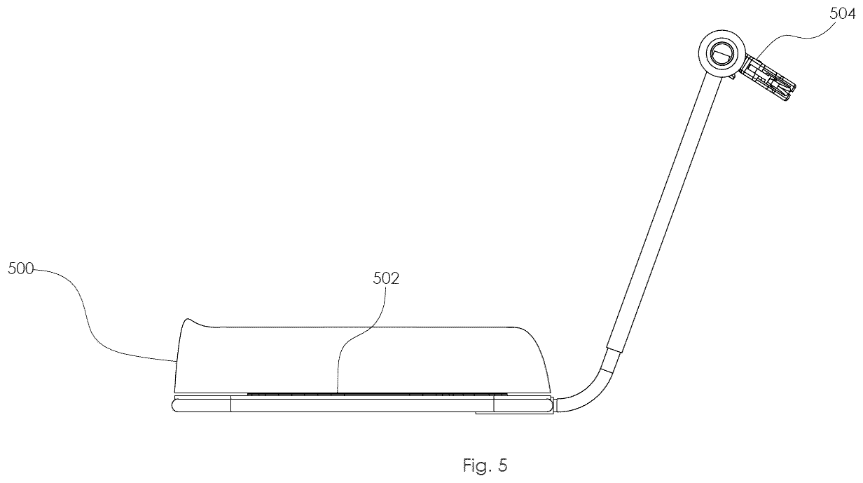

FIG. 5 is an illustration of a side view of a motorcycle-style seat. Motorcycle-style seat 500 includes rider seat pad detection sensor 502 and brake lever 504.

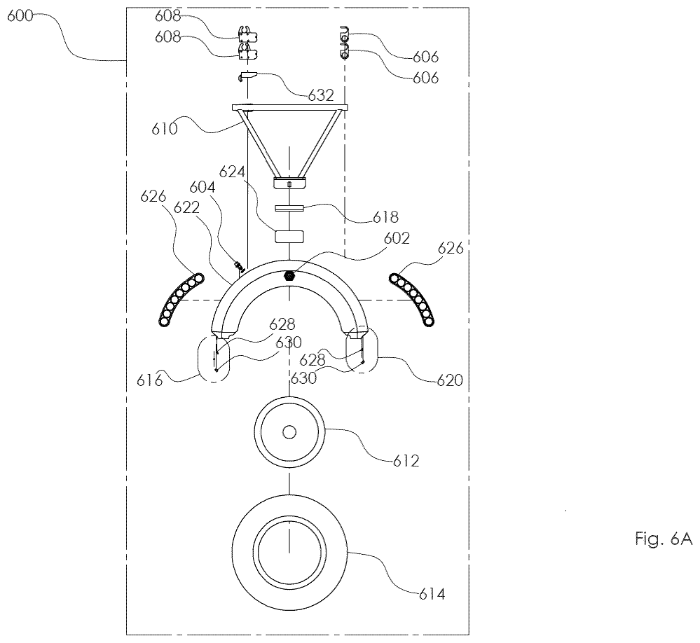

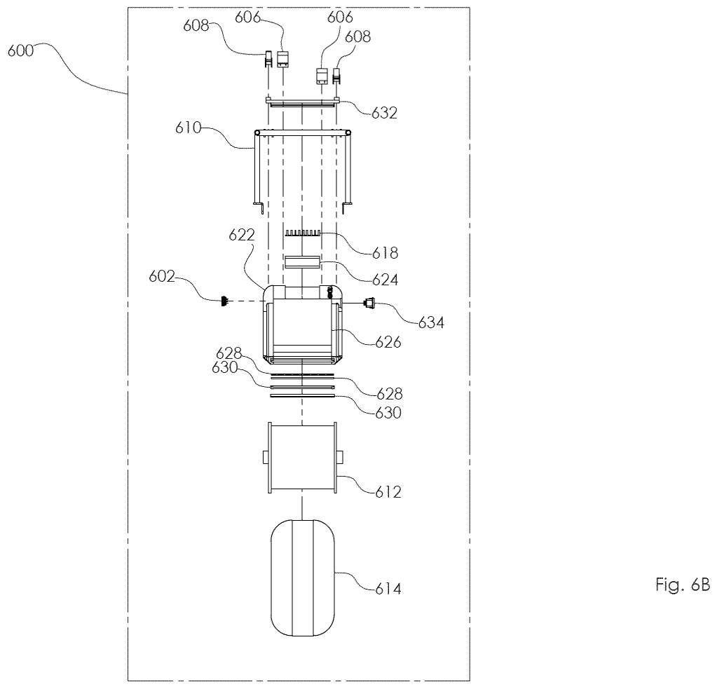

FIG. 6A is an illustration of a side view of a vehicle exploded to show components. Electric self-balancing seated vehicle 600 includes power switch 602, seat and brake sensors port 604, seat mount slotted clamps 606, seat mount bear claw clamps 608, frame 610, hub motor 612, tire 614, headlight 616, heat sink 618, tail light 620, fender enclosure 622, controller 624, battery packs 626, LED lights 628, light covers and lens 630, and seat latch release handle 632.

FIG. 6B is an illustration of a front view of the vehicle exploded to show components. In addition to the components describe in FIG. 6A, charge port 634 is depicted.

The electric self-balancing seated vehicle 100 includes, but is not limited to, the following disclosed elements. The vehicle may be outfitted with a folding lawn-chair style seat 400 or a motorcycle style seat 500.

In function, rider 104 may power on the board using the power switch 302 connecting the battery packs 626 to the controller 624. Rider 104 may sit on a folding lawn-chair style seat 400 or a motorcycle-style seat 500 which is attached to the electric self-balancing seated vehicle 100. If the system is powered on, then when the vehicle is detected to be level using an IMU (inertial measurement unit) of the controller 624, and the rider 100 is detected to be seated by the rider seat pad detection sensor 112, the hub motor 306 and self-balancing features of the electric self-balancing seated vehicle 100 may activate. The rider 104 may keep their feet on the ground even while the vehicle is in motion using the foot mounted wheels 106. No pegs or foot rests are needed or present. The foot mounted wheels 106 may be built into shoes such as roller-skates or rollerblades or they may be attached to normal shoes. With the legs of rider 104 on the ground, rider 104 may control the speed of the vehicle by bending or extending their knees to cause electric self-balancing seated vehicle 100 to tilt forward or backward. When the electric self-balancing seated vehicle 100 is tilted forward it will accelerate and continue to accelerate until the user tilts backward to level. The electric self-balancing seated vehicle 100 may additionally move backward when the user tilts the seat backward, or this function may be eliminated for safety. When the electric self-balancing seated vehicle 100 is nearing the maximum duty cycle of the motor, it may work harder to give the rider 104 the physical feeling of tilting back, which will warn the rider 104 to slow down the vehicle. When the electric self-balancing seated vehicle 100 works harder, it accelerates the user somewhat more than the rider 104 requested thus indicating to rider 104 that they may want to tilt the electric self-balancing seated vehicle 100 backward to slow down the vehicle. An audible indicator in the controller 624 may be used for overspeed warnings as well. Overspeed warnings may be given in other ways as well such as through haptic feedback by an external device or motors already present. When the electric self-balancing seated vehicle 100 is leaned back by rider 103 it will decelerate, and it will continue to do so if rider 104 continues leaning back until it comes to a complete stop. To steer, the rider 104 may use their foot mounted wheels 106 by changing their leg and foot position and orientation while moving. While in the folding lawn-chair style seat 400, arm rests 116 may be used for extra stability and for extra leverage when leaning the vehicle for steering or acceleration control. When using motorcycle style seat 500 the handlebars 214 provide even more leverage useful for controlling the vehicle speeds and turns. Handlebars 214 and arm rests 116 may have a brake-style control lever 105 that triggers the controller 624. The controller may use the brake input for multiple functions depending upon programming, such as to to slow down the hub motor 306 and tire 308, while also performing regenerative braking recharging the battery packs 626, or to tilt the vehicle 100 for ascents or descent.

The hub motor 306 has an axle which is held static between the arms of the frame 610 while the wheel rotates around the axle. Fender enclosure 622 is attached to frame 610 and has a headlight 616 and taillight 620 on front and rear respectively. On top of fender enclosure 622 may be an exposed heat sink 618 used to cool the controller 624. The folding lawn-chair style seat 400 and the motorcycle style seat 500 may be mounted to the electric self-balancing seated vehicle 100 by sliding a tube of the seat frame into the seat mount slotted clamps 304. The other tube of the folding lawn-chair style seat 400 or the motorcycle style seat 500 can then be lowered into the seat mount bear claw clamps 608. A cable may be plugged into the seat and brake sensors port 604 to send rider seat pad detection sensor 112 and brake lever 114 inputs to the controller 624. To remove a folding lawn-chair style seat 400 or a motorcycle style seat 500 from the electric self-balancing seated vehicle 100 the seat latch release handle 632 is pulled which opens both seat mount bear claw clamps 608. The folding lawn-chair style seat 400 or a motorcycle style seat 500 may then be slid out of the seat mount slotted clamps 608 to be removed. The folding lawn-chair style seat 400 can be folded for transportation. The motorcycle style seat 500 handlebars 214 can be collapsed or removed for easy transportation with or without removing the motorcycle style seat 500 from the electric self-balancing seated vehicle 100. In some embodiments, an electric self-balancing seated vehicle 100 may be configured for use with or without handlebars 214. The battery packs 626 can be charged via the charge port 634. The fender enclosure 404 houses LED lights, white for headlight 616 and red for tail light 620, with translucent light covers/lenses 630.

A seat pad detection device is described that acts as a safety mechanism to prevent a self-balancing vehicle from driving off without a rider. The device detects the presence of a human occupant on the seat and sends a signal to activate the vehicle's motors only if the seat is occupied, ensuring that the vehicle cannot operate if there is no rider aboard. This system provides an additional level of safety and helps prevent accidents caused by the vehicle moving without a rider, thereby reducing the risk of injury or damage to the vehicle.

In prior self-balancing devices some have footpad sensors for standing riders. A chair can be retrofitted on these self-balancing devices. The footpad sensors can be activated using a chair and specific chair pads or devices intended to let the chair activate the user footpad detection system. This can be troublesome and at times dangerous, depending upon the method of activating being used. In some devices, the mobility or self-balancing vehicle device settings may be electronically overridden using hardware or software to disable rider detection, creating a dangerous “ghosting” situation where the device may continue riding out of control without a user on board. The embodiment described herein solves the problem of rider detection at the safest location, the seat of the rider. In the case of the rider standing from the seated position or being ejected from the device, the device will safely shut off.

Prior methods do not offer a simple, safe, and reliable method of activating electric vehicles by using occupant detection. The goal of present embodiments is to create a motor activation system which is simple to use, reliable, and offers a higher level of safety for the end users.

Presented embodiments comprise a seat-pad detection sensor which is used to activate the electric device. A flexible seat-mounted sensor will close a circuit which notifies the electric device that the seat is occupied and the motor should be engaged. The system may be coupled with a sensor which detects the orientation of the self-balancing electric device, which can be used to detect that the unit is level in addition to occupied before activating the motor and automatic propulsion logic. The sensor comprises a pressure or weight sensitive sensor, such as the one illustrated in drawings, or others of similar functionality. Multiple sensors may be combined to create a single sensor with multiple zones, in order to control speed or other motor settings in addition to device activation.

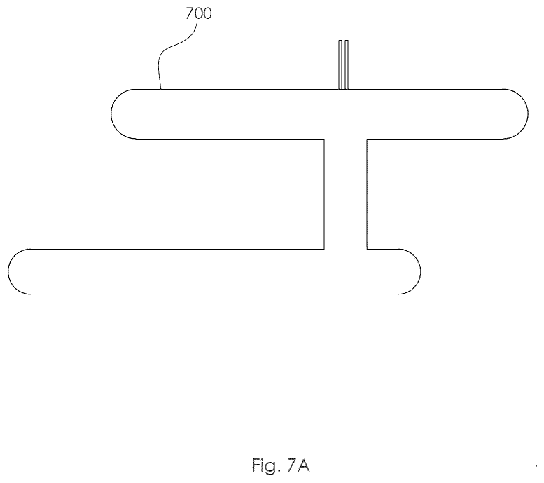

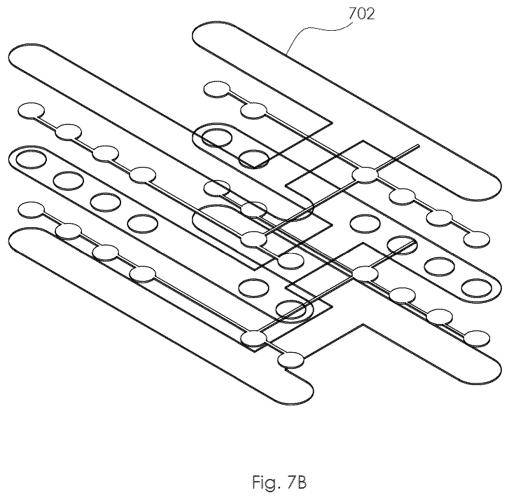

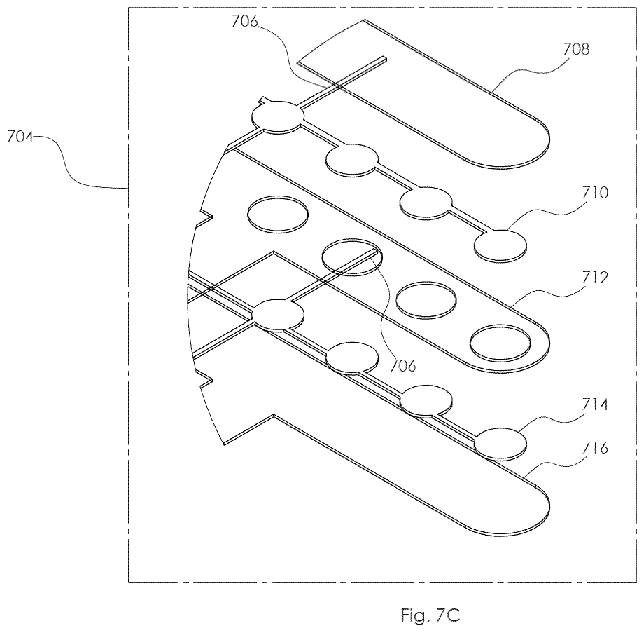

FIG. 7A is an illustration of a sensor for rider detection. One embodiment of a shape of sensor apparatus 700 is shown, although other geometries are possible. Example sensors can be found in seat belt detectors of passenger vehicles.

FIG. 7B is an illustration of an exploded sensor view. Further a detail inset of one geometry of sensor apparatus 702 is shown.

FIG. 7C is an illustration of a detailed exploded view of sensor functionality. The sensor apparatus 704 of the embodiment includes, but is not limited to, wire terminals 706, insulating layer 708, conductive layer 710, insulating layer 712 with holes, conductive layer 714, and insulating layer 716.

The insulating layers (708, 712, 716) may use polyethylene or similar non-conductive material in thin flexible layers. The conductive layers (710, 714) may use carbon ink or a similar flexible conductive material in a thin layer.

Insulating layer 712 has holes that match the large contact pads of the conductive layers 710 and 714. When weight is applied to the sensor apparatus 700 the outer insulated layers 708 and 716 flex along with the conductive materials 710 and 714 until the two conductive layers contact each other. When the two conductive layers 710 and 714 make contact, a voltage applied to one of the terminals 706 will be transferred to the other terminal 706, acting as a pressure switch.

In one embodiment, 3.3 VDC will be applied to a wire electrically connected to one of the terminals 706. The other terminal 706 will be electrically connected to an input on the controller. The controller may read the input and when the input value is above a voltage threshold (approximately 3 to 3.3V) the controller will detect rider 104 as seated and enable the motor(s) of the electric vehicle. When the voltage is not detected, the controller detects the rider 104 as no longer seated.

In one embodiment, this will be used on self-balancing electric vehicles to activate the motor. In this case the inertial measurement unit (IMU) of the controller may require that the skateboard 804 or electric unicycle device 902 be at a specific orientation, likely approximately a level position. It may be used for motor activation on multiple wheeled vehicles, vessels, and aircraft in addition to single-wheeled self-balancing vehicles. In operation, sensor apparatus 700 input signals may be smoothed or conditioned by the controller to prevent spurious results.

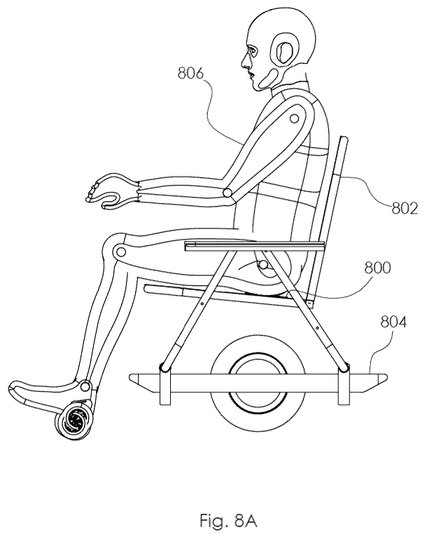

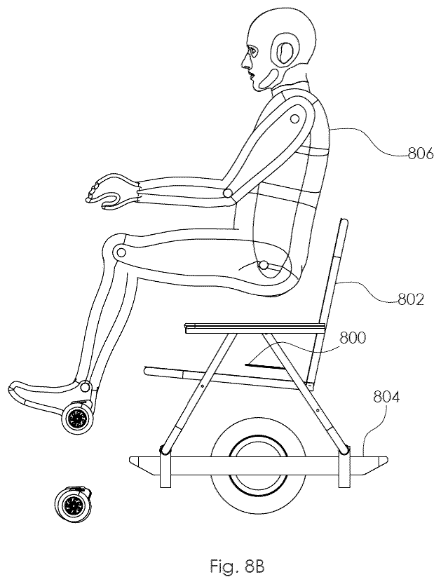

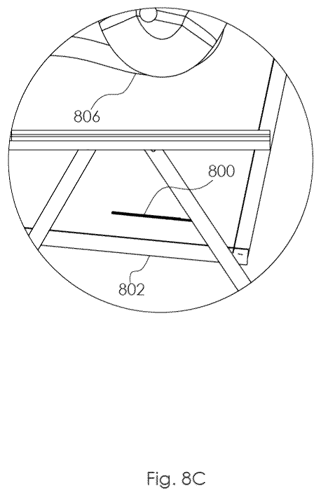

FIG. 8A is an illustration of a chair with sensor and rider in place. The chair is an electric self-balancing seated vehicle that may be activated and controlled by sensor apparatus 800. Sensor apparatus 800 may be wired in different fashions depending upon the exact device, but typically two leads will be wired to a controller for a seat pad detection signal. The sensor apparatus 800 may be mounted to a chair 802. The chair 802 may be mounted to an electric skateboard 804 or an electric unicycle. When a person 806 sits in the chair 802, they activate the sensor 800 which sends signals to the controller of the skateboard 804 or other device.

FIG. 8B is an illustration of an exploded view of chair with rider.

FIG. 8C is an illustration of a detail view showing exploded location of sensor under rider.

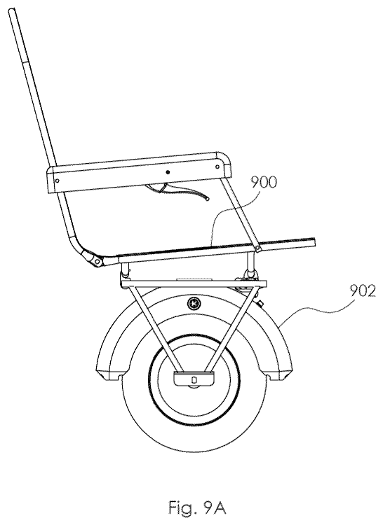

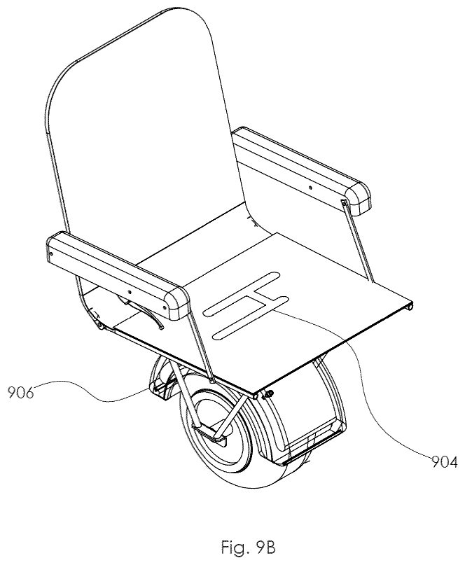

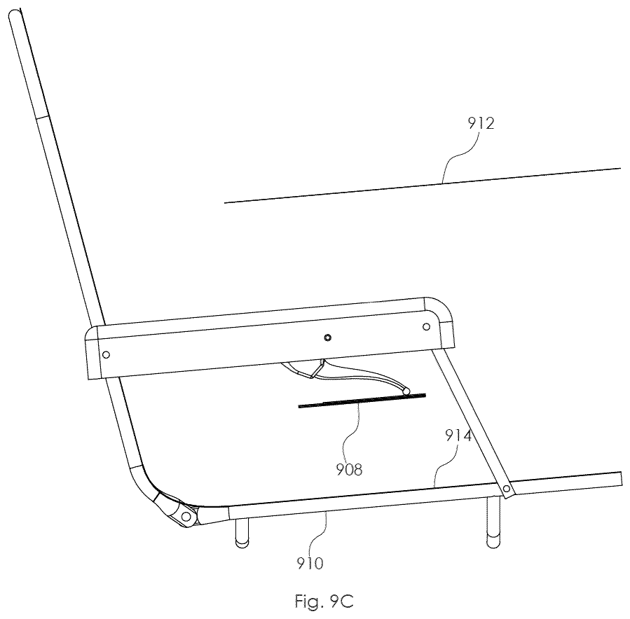

FIG. 9A is an illustration of a view of the seated self-balancing electric unicycle device. The sensor apparatus 900 may be mounted to other types of electric vehicles, including, but not limited to, an electric unicycle device 902.

FIG. 9B is a perspective view showing the sensor apparatus 904 on an electric unicycle device 906.

FIG. 9C is an illustration of an exploded view of a seat pad sensor in a seat. The sensor apparatus 908 may be mounted with a variety of methods, including surface mounted on top of the chair 910 using hook and loop fasteners. It may also be sandwiched between a top layer of fabric 912 and the chair 914 fabric.

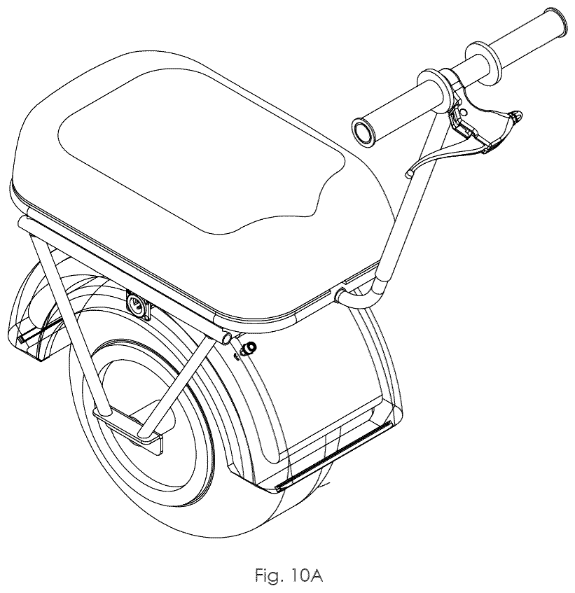

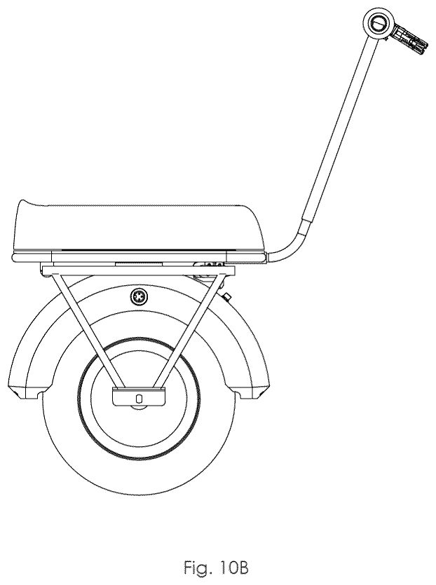

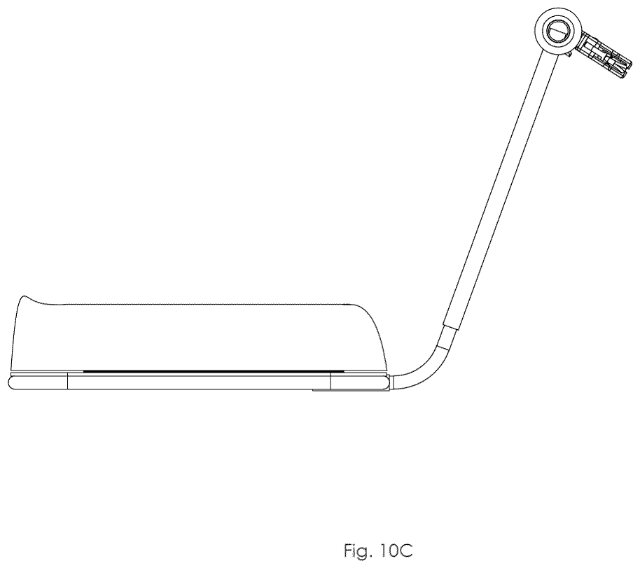

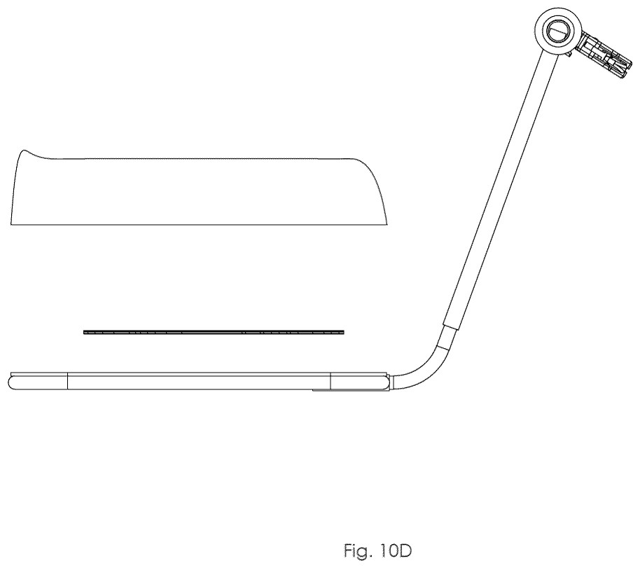

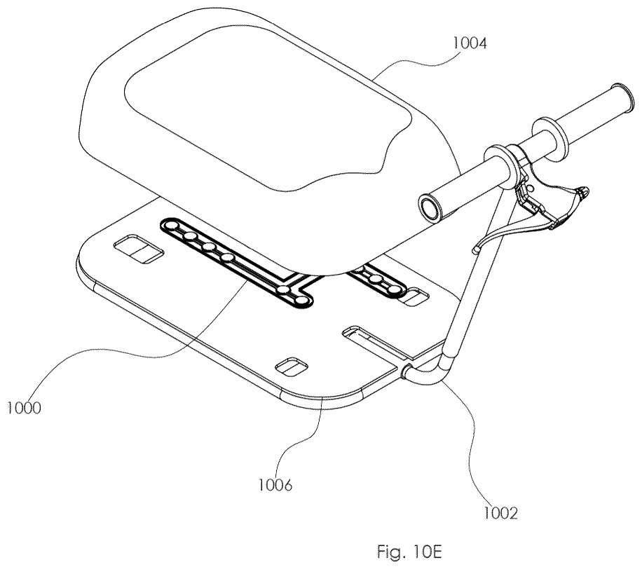

FIG. 10A is an illustration of a perspective view of a self balancing device with an ATV-style seat.

FIG. 10B is an illustration of a side view of the self balancing device.

FIG. 10C is an illustration of a side view of the ATV-style seat.

FIG. 10D is an illustration of an exploded view of the ATV-style seat showing sensor location.

FIG. 10E is an illustration of a perspective exploded view of the ATV-style seat showing sensor location. The sensor apparatus 1000 may also be mounted to different types of seats, including, but not limited to, an all-terrain-vehicle (ATV) or motorcycle style seat 1002. In this case it may be sandwiched between the seat foam or cushion 1004 and the seat base 1006.

The sensor type and mounting location and method may change. Sensors may or may not be permanently mounted and instead placed down before sitting to allow transfer between multiple chairs or seats. The sensor may be replaced with a thin film sensing resistor, mounted and used in similar fashions. The sensor pressure values may be read as analog values and used to control motor speeds or directions in addition to motor activation. The sensor may come with or without cable terminations for various controllers. The sensor may be sold as kits without complete construction. The sensor may be split into two or more detection zones each with individual outputs sent to a controller, to allow the controller to validate complete seating before activating or react to rider location within the seat. For example, a four zone sensor with one zone in each quadrant could be used to detect rider seating position and slow down when the rider is leaning back in their seat, or speed up when the majority of their pressure is on the front of the seat.

In another embodiment, a seat may incorporate clips or other mechanical fasteners to mount a mobile chair to a self-balancing skateboard. This embodiment provides much greater self-centering features than existing methods of attaching chairs to self-balancing vehicles such as electric skateboards, as well as additional safety features and advantages in ease of use. This embodiment accommodates riders with shorter legs that cannot reach the ground well when using alternative methods.

A fender seat for self-balancing electric skateboard is presented as a quickly and easily removable seat that directly attaches to the fender of a self-balancing skateboard. The fender seat may be 3D printed from soft durable and flexible thermoplastic polyurethane (TPU) which allows it to be soft enough for a seat but firm enough to clip into place and remain affixed to the fender without additional hardware. The bottom side of the seat may closely match the contour of the fender in order to distribute the rider's weight across the fender. There may be four arms, one in each corner, that drop below the bottom of the fender and have hooks that grab the edge of the fender, supporting the seat to the fender. Different numbers of arms are possible to allow the seat to be securely attached to the self-balancing skateboard. The seat may have one or more additional appendages for the rider's hands such as handlebars, a control horn similar to a saddle pommel, a control stick similar to an aircraft, or arm rests. The appendages may be removable for easier transport of the seat. The seat may be a single flat cushioned surface like the seat of an all-terrain-vehicle, or it may have a back rest or sissy bar. The back rest may be able to be folded down for easy transport like a folding beach chair. The handlebars or other hand controls allow the rider additional control by giving them additional locations to apply torque to the orientation of the electric skateboard which can be used for accelerating, decelerating, steering, and just keeping stabile on the vehicle while in motion. Additional appendages may be added which apply the rider's weight to the skateboard's footpad rider detection sensor, to activate the skateboard when the rider sits on the seat. A return spring may be added between the seat and fender to lift the footpad detection sensor activation appendages off of the footpad when the rider gets off of the vehicle. The height of the seat may be universal or there may be short seats for shorter riders and taller seats for taller riders.

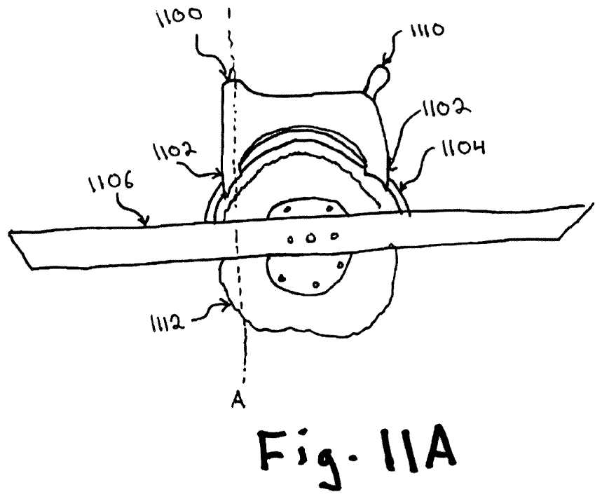

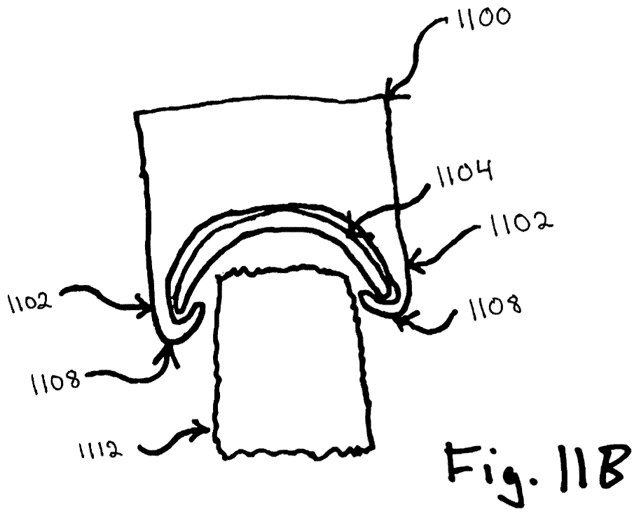

FIG. 11A is an illustration of side view of a seat mounted to a self-balancing unicycle skateboard. Seat apparatus 1100 includes, but is not limited to, mount arms 1102. Mount arms 1102 typically mount to fender 1104 of electric skateboard 1106 using one clip 1108 on each arm. The seat may have a fixed or removable handle control device 1110 to give the rider handholds. Seat 1100 may also replace fender 1104 entirely by using its mounting locations and spanning the distance over the tire 1112.

FIG. 11B is an illustration of a cutaway front view along plane A of FIG. 11A.

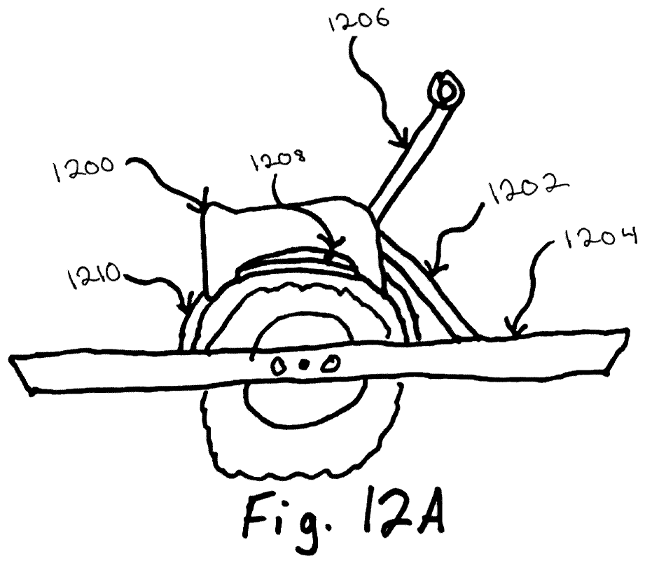

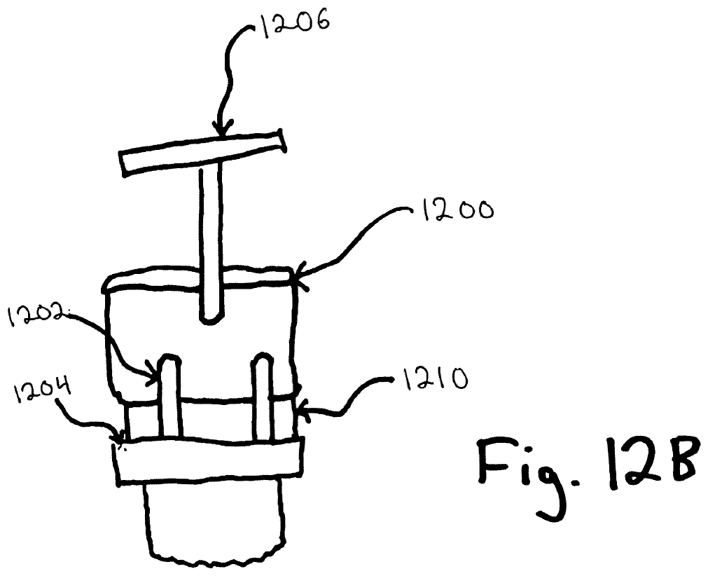

FIG. 12A is an illustration of a side view of a seat mounted to a self-balancing unicycle skateboard with handlebars and footpad sensor activation protrusions. Seat apparatus 1200 may include foot sensor activation protrusions 1202 on the front of the board to activate the rider detection sensor in the front footpad 1204. Foot sensor activation protrusions 1202 and handle control device 1206 may be removable via press fit or fasteners. A return spring 1208 may be used between seat apparatus 1200 and fender 1210 to ensure that when a rider dismounts the rider detection sensor in the front footpad 1204 is deactivated.

FIG. 12B is an illustration of a front view of FIG. 12A.

The seat apparatus 1100 for an electric self-balancing skateboard or a standard electric skateboard may clip, bolt, strap, or otherwise fasten to an existing fender and creates a soft surface intended for a rider to sit on. Mount arms may instead mount directly to electric skateboard at screw-mount locations typical of a fender on a skateboard. It may also be designed directly into the fender itself and produced as a single part, or a multitude of parts that install in the original fender mount holes and extend over the tire in a fashion that is intended to hold a seated person. It may include an additional appendage to allow for hand controls, including arm rests, handlebars, a control stick, or a saddle-like pommel.

The seat apparatus 1100 may be built as multiple pieces and assembled mechanically rather than 3D printed. The seat may be molded, cast, machined, or produced otherwise, without limitation. Seat and/or fender may include a metal frame for strength with additional soft appendages for comfort. Framed seat may be of a folding type with a separate part used to mount to fender.

The seat apparatus 1100 may include appendages on the front of the seat which are intended to apply pressure to the front skateboard footpad when a rider is seated to activate the skateboard, the appendages may be removable for easier transport. The footpad activation protrusions may be combined from two pieces into a single piece which puts pressure on both halves of the footpad pressure sensor of the electric skateboard.

In some embodiments, foot attached wheels may include automatic emergency braking. When riding in a seated position, the majority of a rider's weight is on the seat and little weight remains on the heel wheels. In the case of a fall, bail, or walking or mounting the vehicle, while wearing foot mounted wheels, it may be difficult for the rider to stand without the wheels rotating from underneath them similar to roller skates or ice skates. For additional safety, foot mounted wheels may include a brake mechanism that stops the wheel(s) from rotating when a downward pressure threshold is applied by the rider. This may include a pivot point and a mechanical spring or flex point which allows the axle(s) of the wheel(s) to move upward into a brake pad or wheel lock when sufficient downward pressure is applied.

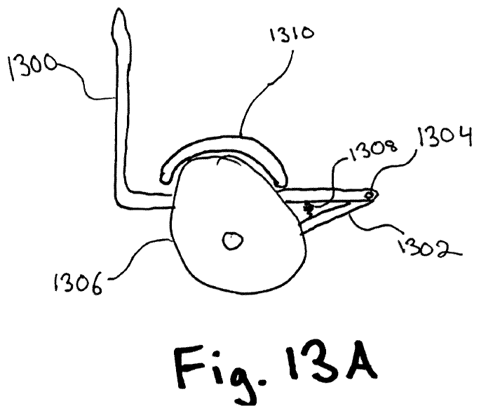

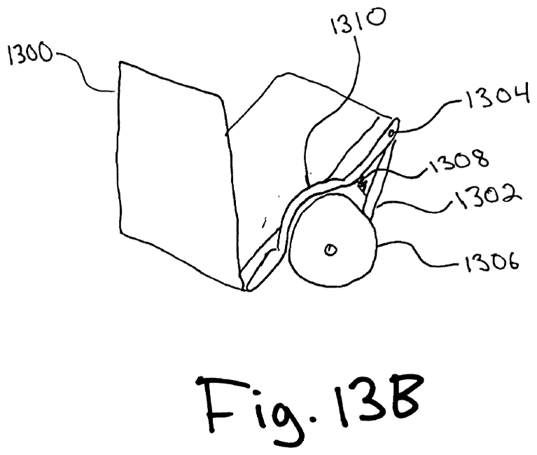

FIG. 13A is an illustration of a side view an automatic braking wheel attachment. The wheel frame 1300 may have a swingarm 1302 with a joint at a pivot point 1304. The wheel 1306 may be attached to a swingarm 1302. In some embodiments, a spring 1308 may be attached between the swingarm 1302 and the wheel frame 1300. Above the wheel 1306 there may be a mechanical brake pad 1310 which may slow the rotation speed of the wheel when the spring 1308 is compressed. Other embodiments may use flexible materials to allow the wheel 1306 to contact the brake pad 1310 when downward force is applied to the wheel frame 1300 to stop the wheel 1306 from rotating.

FIG. 13B is an illustration of a perspective view of FIG. 13A.

In some embodiments, the self-balancing seated vehicle may include wireless communications including but not limited to Bluetooth and WiFi. The wireless communication may be used for controls such as the brake and control lever, throttle levers, or may be used to activate external controller outputs such as lights, horns, blinkers, or speakers. The wireless controller may be removable from the device or even wearable.

In some embodiments, the foot mounted wheel assemblies may include sensors. These sensors may include gyro meters, accelerometers, pressure meters, and speed meters. These sensors may wireless communicate with the self-balancing seated vehicle to alter control characteristics for better user experience. If it is detected that the rider is attempting to turn at high speeds, the controller may detect the wireless signal and react by changing the vehicle tilt and acceleration response during the curve. If it is detected that not enough pressure is being placed on the heel wheels, the vehicle may slow down or tilt the nose forward to assist the rider with reaching the ground for complete control.

In some embodiments, foot wheels may be adapted with brakes. They may be mechanical, or they may be electrical with the possibility of regenerative braking collection. Using wireless communication with the controller, and sensors placed in the heel wheel assemblies, the vehicle may sense that a rider is trying to perform a tight turn while at a low speed by detection the orientation of their feet using the foot mounted wheel assemblies. The vehicle may command the foot mounted wheel assembly on the inside of the turn to apply braking to assist with pivoting of the vehicle.

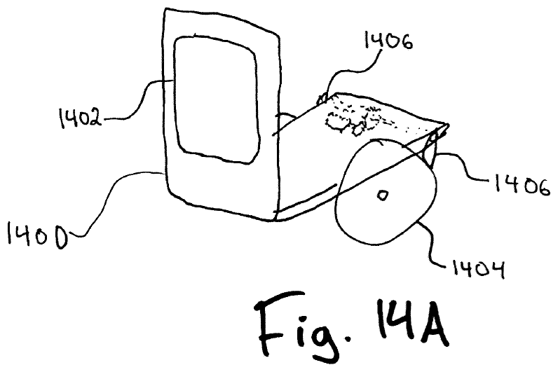

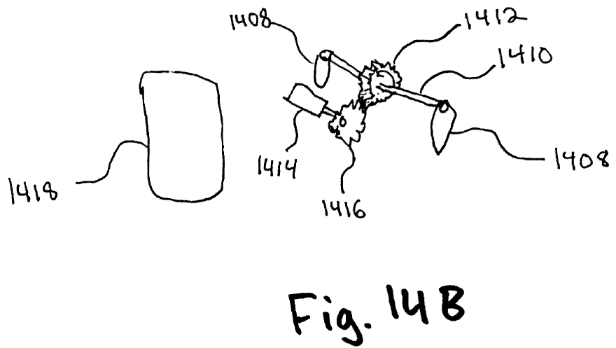

FIG. 14A is a perspective view of an illustration of one embodiment of an intelligent foot mounted wheel. The wheel frame 1400 may have an attached or embedded controller 1402.

The controller 1402 may include batteries and wireless communications as well as USB port for charging, not shown. The wheels 1404 may be attached directly to the wheel frame 1400. The frame 1400 may have a brake wedge 1406 which may lock against the wheel 1404 to slow the rotation speed and provide braking.

FIG. 14B is an internal view of FIG. 14A and shows an embodiment where the brake wedges 1408 may be fixed to a shaft 1410 with a gear 1412. A brake motor 1414 may rotate a gear 1416 when commanded by the controller 1418. The brake motor 1414 gear 1416 may rotate the shaft 1410 gear 1412 to rotate the brake wedges 1408 and enable braking.

All publications and patent applications mentioned in this specification are herein incorporated by reference to the same extent as if each individual publication or patent application was specifically and individually incorporated by reference.

The foregoing description of representative embodiments has been presented for purposes of illustration and description. It is not intended to be exhaustive or to limit the claims to the precise form disclosed, and modifications and variations are possible in light of the above teachings or may be acquired from practice. The embodiments were chosen and described in order to explain the principles of the claims and its practical embodiments to enable one skilled in the art to utilize the claims in various embodiments and with various modifications as are suited to the particular use contemplated. While some embodiments comprise the disclosed features and may therefore include additional features not specifically described, other embodiments may be essentially omitted or completely omitted.

It should be appreciated that those skilled in the art will be able to devise various arrangements, which, although not explicitly described or shown herein, embody the principles of the invention and are included within its spirit and scope. Furthermore, all examples and conditional language recited herein are intended to be only for pedagogical purposes to aid the reader in understanding the principles of the invention. This disclosure and its associated references are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be appreciated by those skilled in the art that the block diagrams herein represent conceptual views of illustrative circuitry, algorithms, and functional steps embodying the principles of the invention. Similarly, it should be appreciated that any flow charts, flow diagrams, signal diagrams, system diagrams, codes, and the like represent various processes which may be substantially represented in computer-readable medium and so executed by a controller, computer, or processor, whether or not such controller, computer, or processor is explicitly shown. In addition, one or more flow diagrams were used herein. The use of flow diagrams is not intended to be limiting with respect to the order in which operations are performed.

The functions of the various elements shown in the drawings, including functional blocks labeled or discussed as “controller,” “processors,” or “systems,” may be provided through the use of dedicated hardware as well as hardware capable of executing software in association with appropriate software. When provided by a processor, the functions may be provided by a single dedicated processor, by a shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, read-only memory (ROM) for storing software, random access memory (RAM), non-volatile storage, or amalgamations of digital or analog logic. Other hardware, conventional and/or custom, may also be included. Similarly, the function of any component or device described herein may be carried out through the operation of program logic, through dedicated logic, through the interaction of program control and dedicated logic, or even manually, the particular technique being selectable by the implementer as more specifically understood from the context.

Any element expressed herein as a means for performing a specified function is intended to encompass any way of performing that function including, for example, a combination of circuit elements which performs that function or software in any form, including, therefore, firmware, micro-code or the like, combined with appropriate circuitry for executing that software to perform the function. The invention as defined herein resides in the fact that the functionalities provided by the various recited means are combined and brought together in the manner which the operational descriptions call for. Applicant regards any means which can provide those functionalities as equivalent as those shown herein.

The invention claimed is:

1. A self-balancing single wheeled electric vehicle comprising:
a seat attached to a frame wherein the seat is positioned to be low enough that a user can set a tilt of the seat with a foot of the user;
a motorized hub attached to the frame;
a wheel attached to the motorized hub;
a controller attached to the frame that activates the motorized hub to move forward when the seat is tilted forward and activates the motorized hub to slow when the seat is tilted backward.

2. The self-balancing single wheeled electric vehicle of claim 1 wherein the seat bottom has a height of less than 22″ from the ground in level riding position.

3. The self-balancing single wheeled electric vehicle of claim 1 wherein there are no footpad provisions for a foot of a rider.

4. The self-balancing single wheeled electric vehicle of claim 1 wherein the wheel has an outer diameter of less than 16″ and the seat is no more than 22″ from the ground.

5. The self-balancing single wheeled electric vehicle of claim 1 further comprising a seat pad weight sensor operatively coupled to the controller such that the controller is unable to activate the motorized hub when a user is not sitting on the seat.

6. The self-balancing single wheeled electric vehicle of claim 1 further comprising a brake lever operatively coupled to the controller to signal the controller to slow the motorized hub when the brake lever is activated.

7. The self-balancing single wheeled electric vehicle of claim 1 further comprising a control lever attached to the frame which allows a user to tilt the seat.

8. The self-balancing single wheeled electric vehicle of claim 7 wherein the control lever folds up or can be removed.

9. The self-balancing single wheeled electric vehicle of claim 1 further comprising a wheel that may be attached to the foot of the user.

10. The self-balancing single wheeled electric vehicle of claim 9 wherein the wheel is attached to a heel on the foot of the user.

11. The self-balancing single wheeled electric vehicle of claim 1 wherein the seat may be detached from the frame.

12. The self-balancing single wheeled electric vehicle of claim 11 wherein the seat is attached to the frame with a slotted clamp and a bear claw clamp.

13. The self-balancing single wheeled electric vehicle of claim 1 where the seat folds up.

14. The self-balancing single wheeled electric vehicle of claim 1 wherein a seat pad detection sensor is operatively to the controller and configured to indicate to the controller when the seat is occupied by the user.

15. The self-balancing single wheeled electric vehicle of claim 1 wherein the controller indicates to the user a maximum speed by causing the motorized hub to speed up further than the tilt of the seat would ordinarily control.

16. The self-balancing single wheeled electric vehicle of claim 1 wherein the controller indicates to the user a maximum speed by activating an audible indicator.

17. The self-balancing single wheeled electric vehicle of claim 1 further comprising an armrest attached to the seat.

18. The self-balancing single wheeled electric vehicle of claim 7 wherein the control lever may be detached from the frame while the controller activates the motorized hub based upon rider tilt without lever or throttle.

19. A seat which attaches to a self balancing wheeled electric vehicle which has provisions for the vehicle's sensor's intended to detect the foot presence of a standing rider.

20. A seat which attaches to a self balancing electric vehicle which has a return mechanism which lifts the seat off of the vehicle's footpad sensor activation when a rider's weight is not applied to the seat.

20. A wheel which may be attached to a foot, which is automatically mechanically braked upon the wearer standing or walking on the wheel.

20. A system of components comprising:

21. A wheel which may be attached to a foot, which includes sensors to wirelessly influence the controls of a self-balancing electric vehicle.

21. A method of operating a self-balancing single wheeled electric vehicle comprising:

22. A wheel which may be attached to a foot, which includes mechanical or electrical brakes which are controlled in sync with a vehicle.
